(19) United States
(12) Patent Application Publication
(10) Pub. No.: US 2017/0019490 A1
(43) Pub. Date: Jan. 19, 2017

(54) MIRRORED VISUALIZATION OF USER ACTIVITY IN USER INTERFACE

(71) Applicant: Apptimize, Inc., Menlo Park, CA (US)

(72) Inventors: Michael L. Poon, San Francisco, CA (US); Lisa Michelle Jakobovits, San Francisco, CA (US)

(21) Appl. No.: 15/211,598

(22) Filed: Jul. 15, 2016

Related U.S. Application Data
(60) Provisional application No. 62/193,162, filed on Jul. 16, 2015.

(51) Int. Cl. H04L 29/08; G06F 3/0481

(52) U.S. Cl. CPC H04L 67/22; G06F 3/0481

(57) ABSTRACT

Techniques to facilitate collection of usage statistics of an application are disclosed herein. In at least one implementation, one or more visual elements of the application that respond to user inputs are determined. Frequency of use information for the one or more visual elements of the application is also determined. The frequency of use information for the one or more visual elements of the application is transferred to an application server, and the application server is configured to calculate usage statistics for the one or more visual elements of the application based on the frequency of use information.

### RELATED APPLICATIONS

This application claims the benefit of, and priority to, U.S. Provisional Patent Application No. 62/193,162, entitled “MIRRORED VISUALIZATION OF USER ACTIVITY IN USER INTERFACE” filed Jul. 16, 2015, which is hereby incorporated by reference in its entirety for all purposes.

### TECHNICAL BACKGROUND

Modern computing systems such as smartphones, tablets, and other mobile devices enable users to install and run various applications. Some applications may be configured with analytics engines that are called during the operation of the device. For example, the main program code of a mobile application may be configured to send function calls to an analytics module to collect and process analytics data about how the device is operated.

In the fields of computer hardware and software technology, it is possible in various runtime environments to modify how a method, function, class, or other such software component maps to the actual code implementation of the component. Sometimes referred to as swizzling, such re-mapping technology allows code associated with one function to be replaced by code associated with another function. This may be useful in the context of making modifications to a user interface, for example.

Some implementations of re-mapping technology involve modifying the value of a pointer that points to a location in memory where a method is implemented in code. By changing the value of the pointer, the method can be made to point to other code such that, when the method is called, a different method is employed in its place. The target method that is called in place of the original method is sometimes referred to as a callback function.

### Overview

Techniques to facilitate collection of usage statistics of an application and to facilitate visualization of usage in the application are disclosed herein. In at least one implementation, one or more visual elements of the application that respond to user inputs are determined. A frequency of use of the one or more visual elements of the application is also determined. The frequency of use of the one or more visual elements of the application are transferred to an application server, and the application server calculates usage statistics for the one or more visual elements of the application based on the frequency of use. A computing system having the application installed thereon may receive the usage statistics transferred from the application server for one or more visual elements of the application. The computing system may then display the usage statistics for the one or more visual elements of the application integrated along with the one or more visual elements of the application. For example, each one of the usage statistics may be displayed proximate to its respective one of the visual elements of the application.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates a communication system.

FIG. 2 is a flow diagram that illustrates an operation of the communication system.

FIG. 3 is a flow diagram that illustrates an operation of the communication system.

FIG. 4 illustrates a graphical user interface (GUI) of an application in an exemplary embodiment.

FIG. 5 illustrates a graphical user interface (GUI) of an application in an exemplary embodiment.

FIG. 6 is a block diagram that illustrates a computing system.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Mobile application designers often desire to make changes and updates to visual elements and other aspects of the user interface of an application. Ordinarily, such changes would require the application developers to edit program code to implement the new application design requirements. However, a framework can be installed into a mobile application which can receive and interpret changes to visual properties of display elements, providing a quick and easy way for designers to edit the user interface of a mobile application without having to write any programming code. This same framework can be utilized to determine visual elements of an application that are responsive to user inputs, track user interactions with the visual elements to determine frequencies of use of each of the visual elements, and transfer the frequencies of use of the visual elements to an application server. The application server can then calculate usage statistics for the visual elements of the application based on their frequency of use as reported by multiple devices running the application. In some implementations, the application could have an administrator mode that enables a developer of the application to receive the usage statistics transferred from the application server and display the usage statistics integrated along with their respective visual elements within the application.

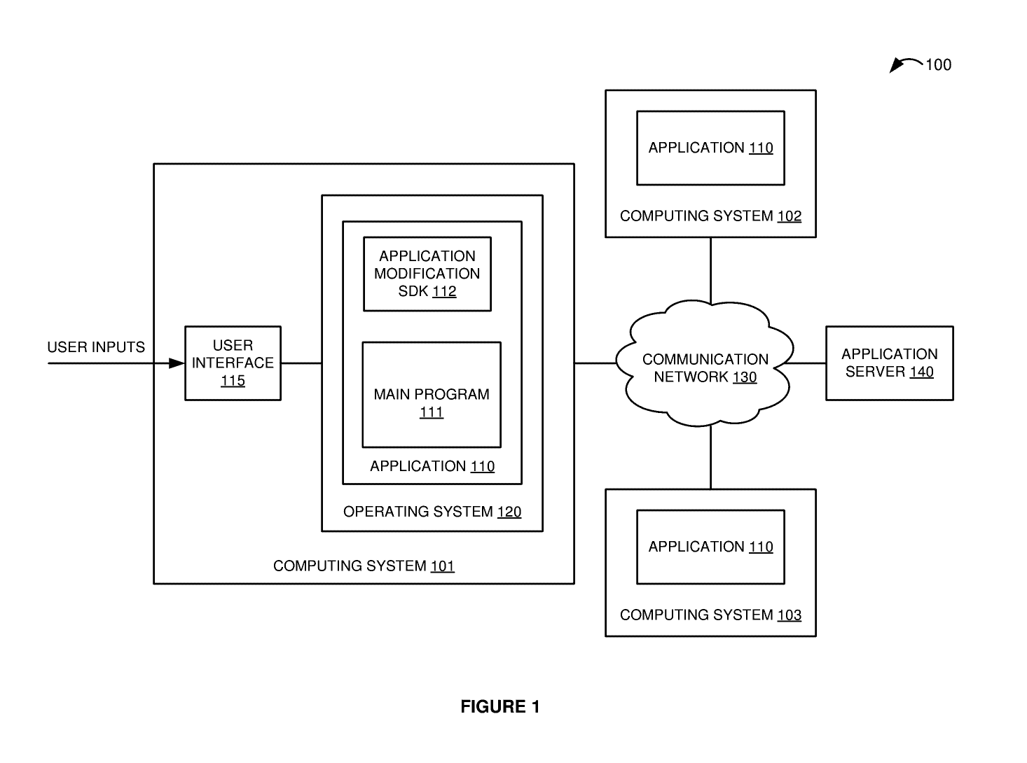

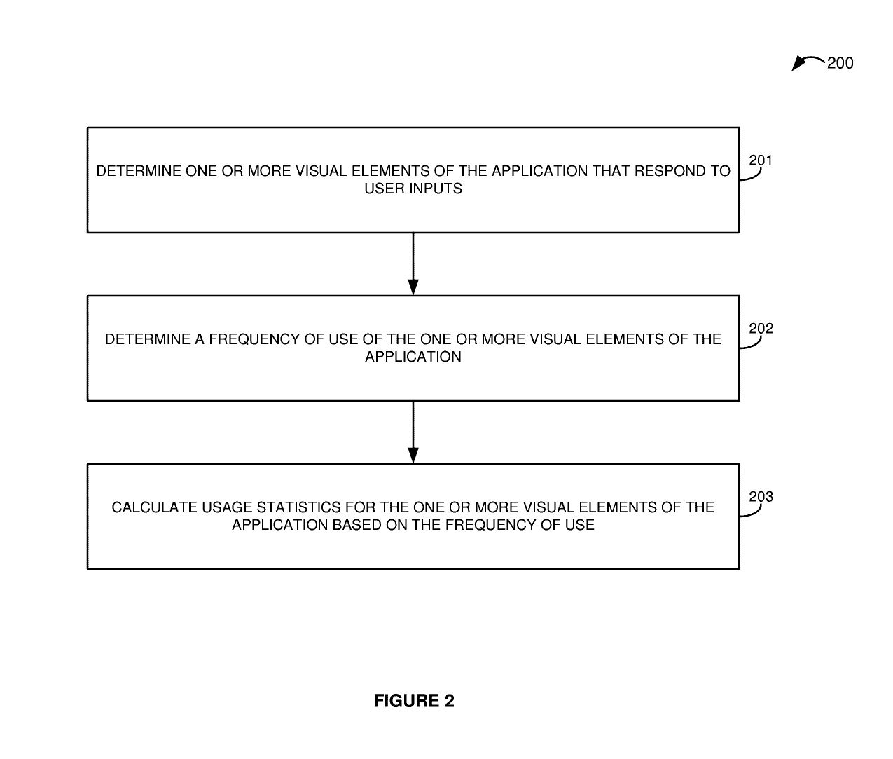

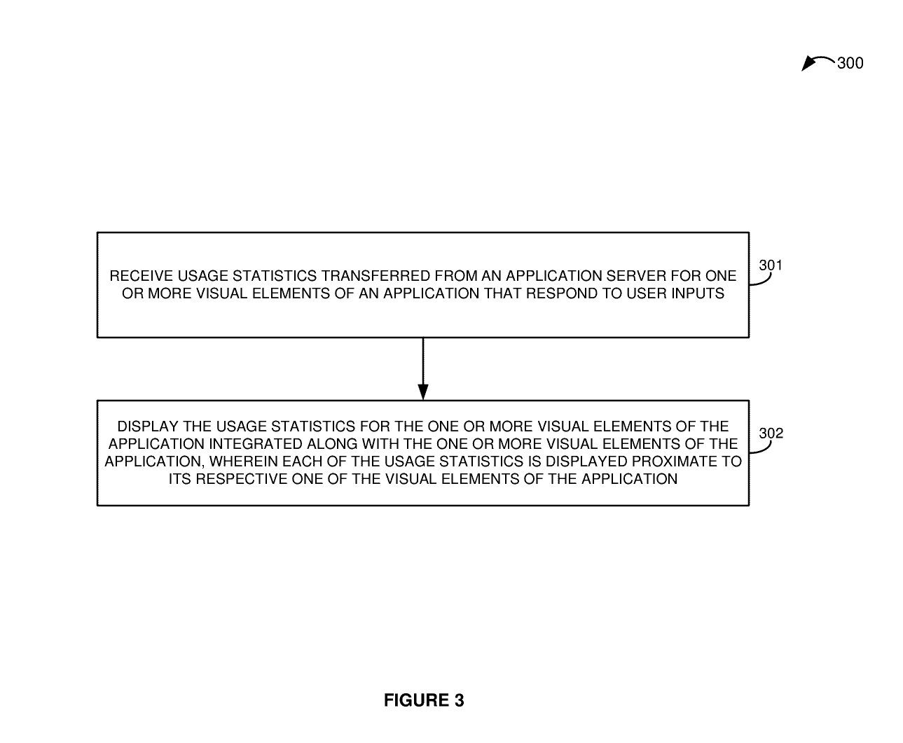

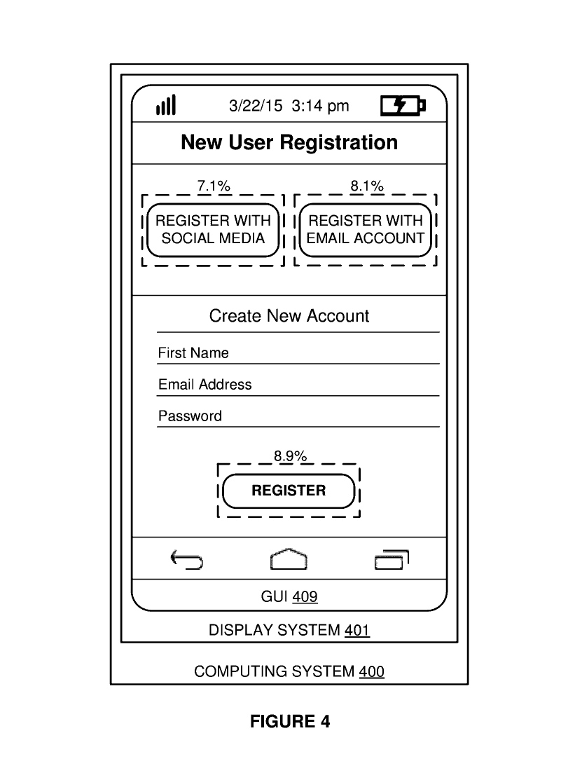

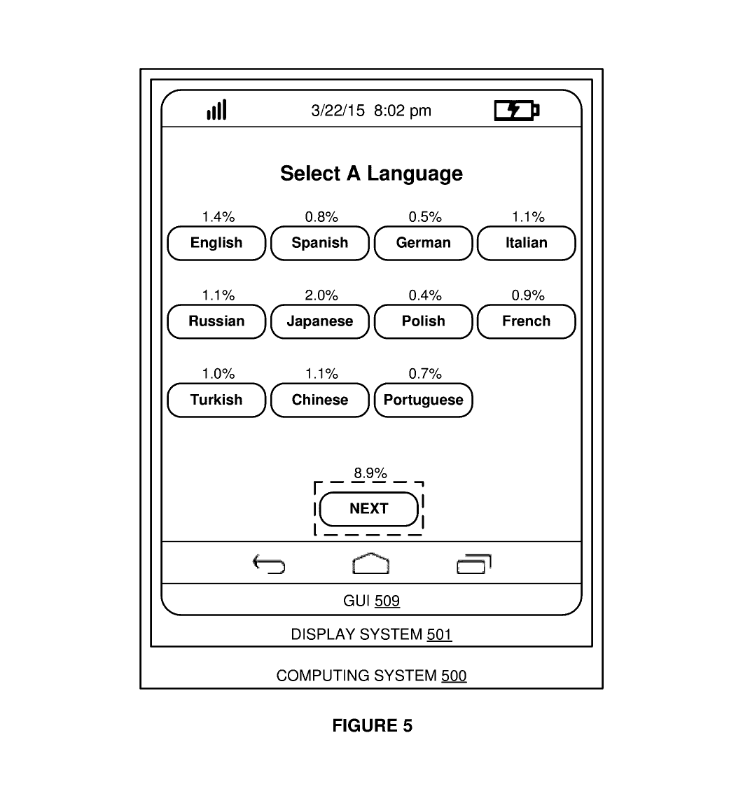

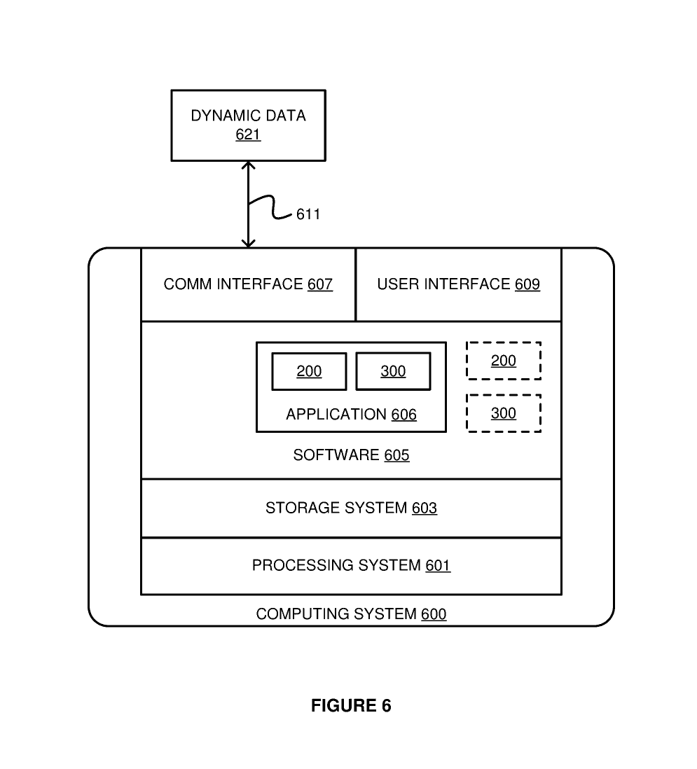

Referring now to the drawings, FIG. 1 illustrates a communication system that may be utilized to determine frequency of use of visual elements and integrate usage statistics with the visual elements of an application. FIG. 2 is a flow diagram that illustrates a usage statistics collection process that may be employed by the communication system. FIG. 3 is a flow diagram that illustrates a usage visualization process that may be performed by the communication system. FIGS. 4 and 5 provide exemplary graphical user interfaces displaying usage statistics proximate to their respective visual elements. FIG. 6 illustrates an exemplary computing system that may be used to perform any of the usage statistics collection processes, usage visualization processes, and operational scenarios described herein.

Turning now to FIG. 1, a block diagram of communication system 100 is illustrated. Communication system 100 includes computing systems 101, 102, and 103, communication network 130, and application server 140. Computing system 101 includes operating system 120, application 110, and user interface 115. Application 110 runs on operating system 120. User interface 115 and operating system 120 typically communicate over a bus communication device. User interface 115 receives user inputs from a user of computing system 101 which are received and processed by components of operating system 120 such as device drivers and passed on to application 110 if applicable. Application 110 comprises main program 111 and application modification software development kit (SDK) 112, which are typically implemented as different software modules of application 110. Main program 111 comprises the primary program instructions for the functionality of the application, such as streaming video, social networking, email, instant messaging, weather, navigation, or any other mobile application. Application modification SDK 312 is typically installed into application 110 to facilitate changes and updates to a user interface and other visual elements of the application 110, perform A/B testing of different application design variants, and other functionality. As shown in FIG. 1, computing systems 102 and 103 also include application 110 which would include the same internal modules 111 and 112, along with an operating system and user interface, although these components are not shown for clarity. An operation of communication system 100 will now be discussed with respect to FIG. 2.

FIG. 2 is a flow diagram that illustrates an operation of communication system 100 in an exemplary implementation. The operation 200 shown in FIG. 2 may also be referred to as usage statistics collection process 200 herein. The steps of the operation are indicated below parenthetically. The following discussion of operation 200 will proceed with reference to computing systems 101-103, the elements of application 110, and application server 140 of FIG. 1 in order to illustrate its operations, but note that the details provided in FIG. 1 are merely exemplary and not intended to limit the scope of process 200 to the specific implementation of FIG. 1.

Operation 200 may be employed by computing systems 101-103 to facilitate collection of usage statistics of application 110. As shown in the operational flow of FIG. 2, one or more visual elements of application 110 that respond to user inputs are determined (201). Typically, a developer or some other interested party associated with application 110 might specify the one or more visual elements of application 110 that should be monitored, but these elements could be determined by application 110 and/or its component software modules 111 and 112 in some examples. In at least one implementation, application modification SDK 112 is installed into application 110 to facilitate implementing changes to visual elements appearing in the application, among other functionality. In the example of computing system 101, application modification SDK 112 could determine one or more visual elements of application 110 that respond to user inputs. For example, application modification SDK 112 could determine visual elements of application 110 that respond to user inputs such as button selections, page navigations, text inputs, menu selections, or any other user interactions. Application modification SDK 112 could also receive notification of such user inputs from main program 111 in some implementations. For example, main program 111 could call a function of application modification SDK 112 or some other third party analytics module that includes parameters that indicate one or more visual elements of the application that respond to user inputs. Other techniques of determining visual elements of application 110 that respond to user inputs are possible and within the scope of this disclosure.

Frequency of use information for the one or more visual elements of application 110 is determined (202). In operation, application modification SDK 112 could track how often the user interacts with the one or more visual elements of application 110 to determine the frequency of use information for each visual element. For example, application modification SDK 112 could determine the frequency of use information for the one or more visual elements of the application by monitoring for and counting user interactions with the one or more visual elements of the application. In some implementations, main program 111 could communicate the frequency of use information for the one or more visual elements to application modification SDK 112. Additionally or alternatively, main program 111 could be configured to make analytics function calls to a third party analytics module that include statistics related to the frequency of use of visual elements of application 110. In this case, application modification SDK 112 could monitor for and intercept the analytics function calls from main program 111 to the third party analytics module and process the analytics function calls to determine the frequency of use information for the one or more visual elements. For example, application modification SDK 112 could process the analytics function call to read a string that defines a user input event associated with a particular visual element, and use this information in determining a frequency of use of that visual element.

The frequency of use information for the one or more visual elements of application 110 is transferred to application server 140 (203). Typically, the usage statistics are individually associated with their respective visual elements. The frequencies of use of the visual elements of application 110 that are collected by application modification SDK 112 are transferred by computing systems 101-103. In some implementations, as application server 140 receives the frequencies of use of the visual elements that respond to user inputs, application server 140 could discover and catalog every visual element of application 110 with which a user may interact. Regardless, after the frequency of use information for the one or more visual elements of application 110 is received, application server 140 is configured to calculate the usage statistics for the one or more visual elements of application 110 based on the frequency of use information (203). In at least one implementation, application server 140 could calculate the usage statistics as a percentage of the number of times that one or more users select or interact with a particular visual element relative to other visual elements as indicated in the frequency of use information received from computing systems 101-103. For example, application server 140 could calculate an average usage frequency of a given element based on the frequency of use information for that element received from computing systems 101-103. Application server 140 could be configured to calculate usage statistics for the one or more visual elements of application 110 in any other manner in other examples. A technique to display the usage statistics in the application alongside their associated visual elements will now be described with respect to usage visualization process 300 of FIG. 3.

FIG. 3 is a flow diagram that illustrates an operation of communication system 100 in an exemplary implementation. The operation 300 shown in FIG. 3 may also be referred to as usage visualization process 300 herein. The steps of the operation are indicated below parenthetically. The following discussion of operation 300 will proceed with reference to FIG. 1 in order to illustrate its operations, but note that the details provided in FIG. 1 are merely exemplary and not intended to limit the scope of process 300 to the specific implementation of FIG. 1.

Operation 300 may be employed by computing system 101 to facilitate visualization of usage in an application 110. As shown in the operational flow of FIG. 3, usage statistics transferred from application server 140 are received for one or more visual elements of application 110 that respond to user inputs (301). Typically, the usage statistics are received by computing system 101 after entering into an administrator mode of application 110 which is configured to receive the usage statistics from application server 140. Each instance of application 110 running on computing systems 101-103 would have an administrator interface included therein, but would only be accessibly to developers of application 110 or those with the proper credentials. The usage statistics received by application 110 are typically generated by application server 140 as described above with respect to operation 200 of FIG. 2.

The usage statistics for the one or more visual elements of application 110 are displayed and integrated along with the one or more visual elements of application 110 (302). Typically, each one of the usage statistics is displayed proximate to its respective one of the visual elements (302). For example, application modification SDK 112 could direct computing system 101 to display a visualization of how users are utilizing application 110 by overlaying the usage statistics over their related visual elements. In other words, application modification SDK 112 of application 110 could be configured to display the usage statistics over the actual GUI display screens of application 110 at the locations of each of the visual elements to show the statistics for multiple users of application 110.

Advantageously, usage statistics for visual elements of application 110 are displayed where their associated visual elements are located. By integrating the display of the usage statistics along with their related visual elements of application 110, interested parties are able to quickly view how frequently each visual element is used by users of application 110. In this manner, developers of application 110 can get a better understanding of how users are utilizing application 110 and its visual elements that respond to user inputs, thereby enabling them to make improvements to button locations, prominence, coloration, or any other user interface properties. Some exemplary screen shots of graphical user interfaces of applications that have usage statistics displayed next to their associated visual elements will now be described with respect to FIGS. 4 and 5.

Referring now to FIG. 4, a graphical user interface (GUI) 409 of a mobile application is illustrated. GUI 409 of the mobile application is displayed on display system 401 of computing system 400. In this example, the user is presented with an interface to register for a user account with the web service associated with the mobile application. An application modification SDK has been installed into the application which has identified the “Register With Social Media” and “Register With Email Account” registration buttons, along with the “Register” option under “Create New Account”. These user-selectable visual elements of the application are highlighted in FIG. 4 with gray shading and outlined with dashed lines for clarity. The application modification SDK has also entered into an administrator interface which displays the usage statistics for these registration options directly on GUI 409 and integrated with these selection options. Typically, these usage statistics would have been previously calculated by an application server and transferred to the application for display within the application's administrator interface by the application modification SDK. As shown in FIG. 4, users register for an account using the Social Media registration option 7.1% of the time, using the Email Account registration option 8.1% of the time, and using the “Create New Account” option 8.9% of the time. Evidently, the remaining 75.9% of the time users do not choose to register, possibly navigating away or exiting out of the application instead. Beneficially, an application developer can view this administrator interface and quickly see the usage statistics for the visual elements of the application.

Referring now to FIG. 5, another GUI display screen of a mobile application is illustrated. In this example, the user is presented with an interface to select a language to learn. An application modification SDK has been installed into the application which has identified the different language selection options and a “Next” button to advance to a next screen. The application modification SDK has also entered into an administrator interface mode which displays the usage statistics for the language selection options integrated with their corresponding options. These usage statistics would have typically been previously calculated by an application server and transferred to the application for display within the application's administrator interface by the application modification SDK. As shown in FIG. 5, users of this application have selected English 1.4% of the time, Spanish 0.8%, German 0.5%, Italian and Russian 1.1%, Japanese 2%, Polish 0.4%, French 0.9%, Turkish 1.0%, Chinese 1.1%, and Portuguese 0.7% of the time. Users select the “Next” page option 8.9% of the time. Advantageously, these usage statistics are displayed proximate to their respective visual elements of the application to quickly convey these statistics to an administrator, developer, or some other entity in charge of managing the application.

Now referring back to FIG. 1, computing systems 101-103 each individually comprise a processing system and communication transceiver. Computing systems 101-103 may also include other components such as a user interface, data storage system, and power supply. Computing systems 101-103 may each individually reside in a single device or may be distributed across multiple devices. Examples of computing systems 101-103 include mobile computing devices, such as cell phones, tablet computers, laptop computers, notebook computers, and gaming devices, as well as any other type of mobile computing devices and any combination or variation thereof. Examples of computing systems 101-103 also include desktop computers, server computers, and virtual machines, as well as any other type of computing system, variation, or combination thereof.

Communication network 130 could comprise multiple network elements such as routers, gateways, telecommunication switches, servers, processing systems, or other communication equipment and systems for providing communication and data services. In some examples, communication network 130 could comprise wireless communication nodes, telephony switches, Internet routers, network gateways, computer systems, communication links, or some other type of communication equipment, including combinations thereof. Communication network 130 may also comprise optical networks, packet networks, local area networks (LAN), metropolitan area networks (MAN), wide area networks (WAN), or other network topologies, equipment, or systems—including combinations thereof. Communication network 130 may be configured to communicate over metallic, wireless, or optical links. Communication network 130 may be configured to use time-division multiplexing (TDM), Internet Protocol (IP), Ethernet, optical networking, wireless protocols, communication signaling, or some other communication format, including combinations thereof. In some examples, communication network 130 includes further access nodes and associated equipment for providing communication services to several computer systems across a large geographic region.

Application modification server 140 may be representative of any computing apparatus, system, or systems that may connect to another computing system over a communication network. Application modification server 140 comprises a processing system and communication transceiver. Application modification server 140 may also include other components such as a router, server, data storage system, and power supply. Application modification server 140 may reside in a single device or may be distributed across multiple devices. Application modification server 140 may be a discrete system or may be integrated within other systems, including other systems within communication system 100. Some examples of application modification server 140 include desktop computers, server computers, cloud computing platforms, and virtual machines, as well as any other type of computing system, variation, or combination thereof.

Referring now to FIG. 6, a block diagram that illustrates computing system 600 in an exemplary implementation is shown. Computing system 600 provides an example of computing systems 101-103 or any computing system that may be used to execute usage statistics collection process 200 and usage visualization process 300 or variations thereof, although such systems could use alternative configurations. Computing system 600 includes processing system 601, storage system 603, software 605, communication interface 607, and user interface 609. Software 605 includes application 606 which itself includes usage statistics collection process 200 and usage visualization process 300. Usage statistics collection process 200 and/or usage visualization process 300 may optionally be implemented separately from application 606.

Computing system 600 may be representative of any computing apparatus, system, or systems on which application 606 and usage statistics collection process 200 and usage visualization process 300 or variations thereof may be suitably implemented. Computing system 600 may reside in a single device or may be distributed across multiple devices. Examples of computing system 600 include mobile computing devices, such as cell phones, tablet computers, laptop computers, notebook computers, and gaming devices, as well as any other type of mobile computing devices and any combination or variation thereof. Note that the features and functionality of computing system 600 may apply as well to desktop computers, server computers, and virtual machines, as well as any other type of computing system, variation, or combination thereof.

Computing system 600 includes processing system 601, storage system 603, software 605, communication interface 607, and user interface 609. Processing system 601 is operatively coupled with storage system 603, communication interface 607, and user interface 609. Processing system 601 loads and executes software 605 from storage system 603. When executed by computing system 600 in general, and processing system 601 in particular, software 605 directs computing system 600 to operate as described herein for usage statistics collection process 200 and usage visualization process 300 or variations thereof. Computing system 600 may optionally include additional devices, features, or functionality not discussed herein for purposes of brevity.

Referring still to FIG. 6, processing system 601 may comprise a microprocessor and other circuitry that retrieves and executes software 605 from storage system 603. Processing system 601 may be implemented within a single processing device but may also be distributed across multiple processing devices or sub-systems that cooperate in executing program instructions. Examples of processing system 601 include general purpose central processing units, application specific processors, and logic devices, as well as any other type of processing device, combinations, or variations thereof.

Storage system 603 may comprise any computer readable media or storage media readable by processing system 601 and capable of storing software 605. Storage system 603 may include volatile and nonvolatile, removable and non-removable media implemented in any method or technology for storage of information, such as computer readable instructions, data structures, program modules, or other data. Storage system 603 may be implemented as a single storage device but may also be implemented across multiple storage devices or sub-systems co-located or distributed relative to each other. Storage system 603 may comprise additional elements, such as a controller, capable of communicating with processing system 601. Examples of storage media include random-access memory, read-only memory, magnetic disks, optical disks, flash memory, virtual memory and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In no case is the storage media a propagated signal.

In operation, in conjunction with user interface 609, processing system 601 loads and executes portions of software 605, such as usage statistics collection process 200, to facilitate collection of usage statistics of an application. Software 605 may be implemented in program instructions and among other functions may, when executed by computing system 600 in general or processing system 601 in particular, direct computing system 600 or processing system 601 to determine one or more visual elements of the application that respond to user inputs. Software 605 may further direct computing system 600 or processing system 601 to determine a frequency of use of the one or more visual elements of the application. Software 605 may also direct computing system 600 or processing system 601 to transfer the frequency of use of the one or more visual elements of the application to an application server, wherein the application server calculates the usage statistics for the one or more visual elements of the application based on the frequency of use.

In another operation, in conjunction with user interface 609, processing system 601 loads and executes portions of software 605, such as usage visualization process 300, to facilitate visualization of usage in an application. Software 605 may be implemented in program instructions and among other functions may, when executed by computing system 600 in general or processing system 601 in particular, direct computing system 600 or processing system 601 to receive usage statistics transferred from an application server for one or more visual elements of the application that respond to user inputs. Software 605 may further direct computing system 600 or processing system 601 to display the usage statistics for the one or more visual elements of the application integrated along with the one or more visual elements of the application, wherein each one of the usage statistics is displayed proximate to its respective one of the visual elements of the application.

Software 605 may include additional processes, programs, or components, such as operating system software or other application software. Examples of operating systems include Windows®, iOS®, and Android®, as well as any other suitable operating system. Software 605 may also comprise firmware or some other form of machine-readable processing instructions executable by processing system 601.

In general, software 605 may, when loaded into processing system 601 and executed, transform computing system 600 overall from a general-purpose computing system into a special-purpose computing system customized to facilitate acquisition of analytics data in a mobile application as described herein for each implementation. For example, encoding software 605 on storage system 603 may transform the physical structure of storage system 603. The specific transformation of the physical structure may depend on various factors in different implementations of this description. Examples of such factors may include, but are not limited to the technology used to implement the storage media of storage system 603 and whether the computer-readable storage media are characterized as primary or secondary storage.

In some examples, if the computer-readable storage media are implemented as semiconductor-based memory, software 605 may transform the physical state of the semiconductor memory when the program is encoded therein. For example, software 605 may transform the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 600 is generally intended to represent a computing system with which software 605 is deployed and executed in order to implement application 606 and/or usage statistics collection process 200 and usage visualization process 300 (and variations thereof). However, computing system 600 may also represent any computing system on which software 605 may be staged and from where software 605 may be distributed, transported, downloaded, or otherwise provided to yet another computing system for deployment and execution, or yet additional distribution. For example, computing system 600 could be configured to deploy software 605 over the internet to one or more client computing systems for execution thereon, such as in a cloud-based deployment scenario.

Communication interface 607 may include communication connections and devices that allow for communication between computing system 600 and other computing systems (not shown) or services, over a communication network 611 or collection of networks. In some implementations, communication interface 607 receives dynamic data 621 over communication network 611. Examples of connections and devices that together allow for inter-system communication may include network interface cards, antennas, power amplifiers, RF circuitry, transceivers, and other communication circuitry. The aforementioned network, connections, and devices are well known and need not be discussed at length here.

User interface 609 may include a voice input device, a touch input device for receiving a gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface 609. In some examples, user interface 609 could include a touch screen capable of displaying a graphical user interface that also accepts user inputs via touches on its surface. The aforementioned user input devices are well known in the art and need not be discussed at length here. User interface 609 may also include associated user interface software executable by processing system 601 in support of the various user input and output devices discussed above. Separately or in conjunction with each other and other hardware and software elements, the user interface software and devices may provide a graphical user interface, a natural user interface, or any other kind of user interface. User interface 609 may be omitted in some implementations.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method to facilitate collection of usage statistics of an application, the method comprising:
determining one or more visual elements of the application that respond to user inputs;
determining frequency of use information for the one or more visual elements of the application; and
transferring the frequency of use information for the one or more visual elements of the application to an application server, wherein the application server is configured to calculate the usage statistics for the one or more visual elements of the application based on the frequency of use information.

2. The method of claim 1 further comprising:
receiving the usage statistics for the one or more visual elements of the application that respond to user inputs transferred from the application server; and
displaying the usage statistics for the one or more visual elements of the application integrated along with the one or more visual elements of the application.

3. The method of claim 2 wherein displaying the usage statistics for the one or more visual elements of the application integrated along with the one or more visual elements of the application comprises displaying each one of the usage statistics proximate to its respective one of the visual elements of the application.

4. The method of claim 1 wherein determining the frequency of use information for the one or more visual elements of the application comprises monitoring user interactions with the one or more visual elements of the application.

5. The method of claim 1 wherein determining the frequency of use information for the one or more visual elements of the application comprises intercepting analytics function calls from main program code of the application to an analytics module and processing the analytics function calls to determine the frequency of use information for the one or more visual elements of the application.

6. The method of claim 1 wherein the application server configured to calculate the usage statistics for the one or more visual elements of the application based on the frequency of use information comprises the application server configured to calculate an average usage frequency for the one or more visual elements of the application based on the frequency of use information.

7. The method of claim 1 wherein determining the one or more visual elements of the application that respond to user inputs comprises determining button visual elements of the application.

8. One or more computer-readable storage media having program instructions stored thereon to facilitate collection of usage statistics of an application, wherein the program instructions, when executed by a computing system, direct the computing system to at least:
determine one or more visual elements of the application that respond to user inputs;
determine frequency of use information for the one or more visual elements of the application; and
transfer the frequency of use information for the one or more visual elements of the application to an application server, wherein the application server is configured to calculate the usage statistics for the one or more visual elements of the application based on the frequency of use information.

9. The one or more computer-readable storage media of claim 8 wherein the program instructions further direct the computing system to receive the usage statistics for the one or more visual elements of the application that respond to user inputs transferred from the application server and display the usage statistics for the one or more visual elements of the application integrated along with the one or more visual elements of the application.

10. The one or more computer-readable storage media of claim 9 wherein the program instructions direct the computing system to display the usage statistics for the one or more visual elements of the application integrated along with the one or more visual elements of the application by directing the computing system to display each one of the usage statistics proximate to its respective one of the visual elements of the application.

11. The one or more computer-readable storage media of claim 8 wherein the program instructions direct the computing system to determine the frequency of use information for the one or more visual elements of the application by directing the computing system to monitor user interactions with the one or more visual elements of the application.

12. The one or more computer-readable storage media of claim 8 wherein the program instructions direct the computing system to determine the frequency of use information for the one or more visual elements of the application by directing the computing system to intercept analytics function calls from main program code of the application to an analytics module and process the analytics function calls to determine the frequency of use information for the one or more visual elements of the application.

13. The one or more computer-readable storage media of claim 8 wherein the application server configured to calculate the usage statistics for the one or more visual elements of the application based on the frequency of use information comprises the application server configured to calculate an average usage frequency for the one or more visual elements of the application based on the frequency of use information.

14. The one or more computer-readable storage media of claim 8 wherein the program instructions direct the computing system to determine the one or more visual elements of the application that respond to user inputs by directing the computing system to determine button visual elements of the application.

15. An apparatus comprising:
one or more computer-readable storage media; and
program instructions stored on the one or more computer-readable storage media that, when executed by a processing system, direct the processing system to at least:
determine one or more visual elements of an application that respond to user inputs;
determine frequency of use information for the one or more visual elements of the application; and
transfer the frequency of use information for the one or more visual elements of the application to an application server, wherein the application server is configured to calculate the usage statistics for the one or more visual elements of the application based on the frequency of use information.

16. The apparatus of claim 15 wherein the program instructions further direct the processing system to receive the usage statistics for the one or more visual elements of the application that respond to user inputs transferred from the application server and display the usage statistics for the one or more visual elements of the application integrated along with the one or more visual elements of the application.

17. The apparatus of claim 16 wherein the program instructions direct the processing system to display the usage statistics for the one or more visual elements of the application integrated along with the one or more visual elements of the application by directing the processing system to display each one of the usage statistics proximate to its respective one of the visual elements of the application.

18. The apparatus of claim 15 wherein the program instructions direct the processing system to determine the frequency of use information for the one or more visual elements of the application by directing the processing system to monitor user interactions with the one or more visual elements of the application.

19. The apparatus of claim 15 wherein the program instructions direct the processing system to determine the frequency of use information for the one or more visual elements of the application by directing the processing system to intercept analytics function calls from main program code of the application to an analytics module and process the analytics function calls to determine the frequency of use information for the one or more visual elements of the application.

20. The apparatus of claim 15 wherein the application server configured to calculate the usage statistics for the one or more visual elements of the application based on the frequency of use information comprises the application server configured to calculate an average usage frequency for the one or more visual elements of the application based on the frequency of use information.
